(19) United States
(12) Patent Application Publication
(10) Pub. No.: US 2025/0300368 A1
(43) Pub. Date: Sep. 25, 2025

(54) ANTENNA MODULE AND COMMUNICATION APPARATUS EQUIPPED WITH THE SAME

(71) Applicant: Murata Manufacturing Co., Ltd., Nagaokakyo-shi (JP)

(72) Inventor: Yosuke SATO, Nagaokakyo-shi (JP)

(73) Assignee: Murata Manufacturing Co., Ltd., Nagaokakyo-shi (JP)

(21) Appl. No.: 19/232,035

(22) Filed: Jun. 9, 2025

Related U.S. Application Data
(63) Continuation of application No. PCT/JP2023/036696, filed on Oct. 10, 2023.

(30) Foreign Application Priority Data
Dec. 22, 2022 (JP) 2022-205878

(51) Int. Cl. H01Q 21/24; H01Q 1/52; H01Q 5/28

(52) U.S. Cl. CPC H01Q 21/24; H01Q 1/52; H01Q 5/28

(57) ABSTRACT

An antenna module includes a ground electrode, a first radiating element, a second radiating element larger in size than the first radiating element, a feed wiring line, and a metal member. The first and second radiating elements face the ground electrode. The first and second radiating elements overlap each other in plan view in the normal direction of the ground electrode. The feed wiring line penetrates through the radiating element and a radio frequency signal is transmitted therethrough to the radiating element. The metal member extends from the radiating element in the normal direction without contacting the ground electrode.

### CROSS-REFERENCE TO RELATED APPLICATIONS

The present application is a continuation of international application no. PCT/JP2023/036696, filed Oct. 10, 2023, which claims priority to Japanese patent application JP 2022-205878, filed Dec. 22, 2022, the entire contents of each of which being incorporated herein by reference.

### TECHNICAL FIELD

The present disclosure relates to an antenna module and a communication apparatus equipped with the same, and more specifically, relates to technology for improving antenna characteristics.

### BACKGROUND ART

International Publication No. 2020/217971, specification (Patent Document 1) discloses an antenna module of a stacked type having plate-shaped radiating elements capable of radiating radio waves in two different frequency bands.

### CITATION LIST

### Patent Document

Patent Document 1: International Publication No. 2020/217971, specification

### SUMMARY

### Technical Problems

The antenna module disclosed in Patent Document 1 described above is used for a mobile terminal such as a mobile phone, a smartphone, or a tablet. In the mobile terminal as described above, for example, a radio wave in a 28 GHz band is used on occasions. In recent years, there is a trend of adding, as a new frequency band, a 60 GHz band that is a frequency band twice or more 28 GHz to improve radio traffic and communication quality with the increase of the number of communication apparatuses.

The inventors of the present disclosure have found that an increase in a frequency band difference in the stacked-type antenna module causes a decrease in an antenna gain, in the radiating direction, of a radio wave with a higher frequency.

The present disclosure has been made to address such an issue, as well as other issues, and one aspect is directed to improving the antenna gain of a radio wave with a higher frequency in an antenna module capable of radiating radio waves in two or more different frequency bands.

### Solutions to Problems

An antenna module according to an aspect of the present disclosure and an antenna module according to an aspect each include: a ground electrode; a first radiating element and a second radiating element that are of a plate shape; a first feed wiring line through which a radio frequency signal is transmitted to the first radiating element; and at least one first metal member disposed on the second radiating element. The first radiating element is disposed to face the ground electrode. The second radiating element is larger than the first radiating element in size and is disposed between the ground electrode and the first radiating element to overlap with the first radiating element in plan view in a normal direction of the ground electrode. The first feed wiring line penetrates through the second radiating element. The at least one first metal member is disposed to extend from the second radiating element in the normal direction without coming in contact with the ground electrode.

### Effects of Present Disclosure

According to the antenna module according to the present disclosure, a metal member disposed on a radiating element with a lower frequency (the second radiating element) causes lower electrical coupling between a feed wiring line and the second radiating element, and the second radiating element may be prevented from resonating in a higher-order mode. The antenna gain of a radio wave with a higher frequency radiated from the first radiating element may thus be improved.

### BRIEF DESCRIPTION OF DRAWINGS

FIG. 1 is an example block diagram of a communication apparatus to which an antenna module in Embodiment 1 is applied.

FIG. 2 illustrates a plan view (upper part) and a side perspective view (lower part) of the antenna module.

FIG. 3 is a side perspective view of an antenna module of Comparative Example.

FIG. 4 is a view illustrating simulation results of antenna gains.

FIG. 5 is a graph illustrating simulation results of isolation characteristics.

FIG. 6 is a plan view of an antenna module in Modification 1.

FIG. 7 is a plan view of an antenna module in Modification 2.

FIG. 8 is a view illustrating simulation results of antenna gains.

FIG. 9 is a view illustrating simulation results of antenna gains, in polarization directions, of radio waves in the antenna module in Modification 2.

FIG. 10 is a side perspective view of an antenna module in Modification 3.

FIG. 11 is a side perspective view of an antenna module in Modification 4.

FIG. 12 is a side perspective view of an antenna module in Modification 5.

FIG. 13 is a side perspective view of an antenna module in Embodiment 2.

FIG. 14 is a side perspective view of an antenna module in Embodiment 3.

FIG. 15 is a side perspective view of an antenna module in Embodiment 4.

FIG. 16 is a side perspective view of an antenna module in Embodiment 5.

FIG. 17 is a side perspective view of an antenna module in Embodiment 6.

### DESCRIPTION OF EMBODIMENTS

Hereinafter, embodiments of the present disclosure will be described in detail with reference to the drawings. The same or corresponding components in the drawings are denoted by the same reference numerals, and the description thereof is not repeated.

### Embodiment 1

### (Basic Configuration of Communication Apparatus)

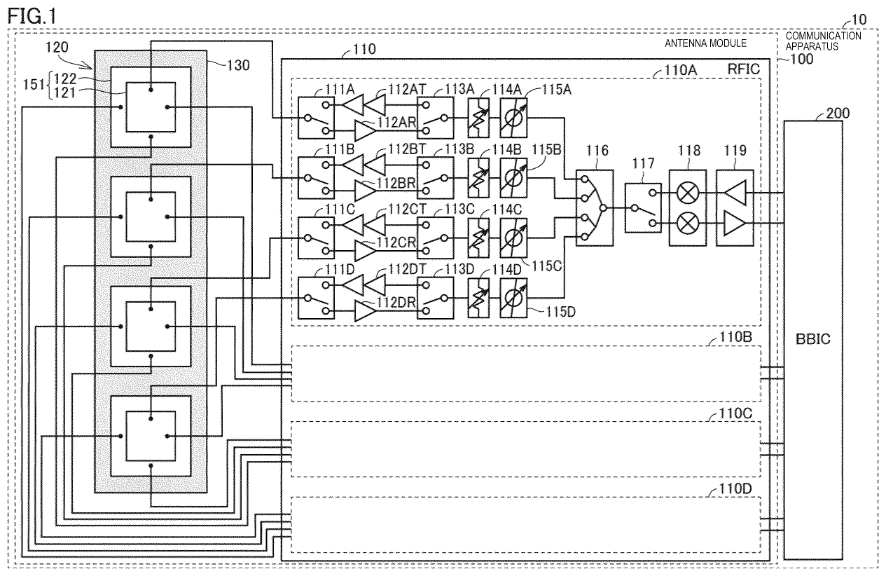

FIG. 1 is an example block diagram of a communication apparatus to which an antenna module in Embodiment 1 is applied. For example, a communication apparatus 10 is a mobile terminal such as a mobile phone, a smartphone, or a tablet, or a personal computer having a communication function. An example of the frequency band of a radio wave used for an antenna module 100 in Embodiment 1 is a radio wave in a millimeter wave band having a center frequency of, for example, 28 GHZ, 39 GHz, 60 GHz, or 100 GHz; however, a radio wave in a frequency band other than above is also applicable.

With reference to FIG. 1, the communication apparatus 10 includes the antenna module 100 and a BBIC 200 forming a baseband signal processing circuit. The antenna module 100 includes: an RFIC 110 that is an example of a feeder circuit; and an antenna device 120. The communication apparatus 10 upconverts a signal transmitted from the BBIC 200 to the antenna module 100 into a radio frequency signal by using the RFIC 110 and radiates the signal from the antenna device 120. The communication apparatus 10 also sends the radio frequency signal received by the antenna device 120 to the RFIC 110, downconverts the signal, and processes the signal by using the BBIC 200.

The antenna device 120 includes a dielectric substrate 130, a plurality of antenna elements 151 disposed in a line on the dielectric substrate 130. FIG. 1 illustrates an example where the plurality of antenna elements 151 are arranged in a line and thereby form a one-dimensional array. Instead of the arrangement as described above, the plurality of antenna elements 151 may be arranged in a two-dimensional array.

Each antenna element 151 is formed as a stacked patch antenna in which each of radiating elements 121 and a corresponding one of radiating elements 122 are stacked. The radiating element 121 radiates a radio wave with a higher frequency, and a radiating element 122 radiates a radio wave with a lower frequency. The radiating elements 121 and 122 are configured to be able to radiate two radio waves in respective different polarization directions. That is, the antenna module 100 including the antenna elements 151 is an antenna module of a so-called dual band type and dual polarization type.

The RFIC 110 includes four feeder circuits 110A to 110D each for the two radiating elements and the two polarized waves. The feeder circuit 110A supplies a radio frequency signal for first polarization to a corresponding one of the radiating elements 121. The feeder circuit 110B supplies a radio frequency signal for second polarization to a corresponding one of the radiating elements 121. The feeder circuit 110C supplies a radio frequency signal for the first polarization to a corresponding one of the radiating elements 122. The feeder circuit 110D supplies the radio frequency signal for the second polarization to a corresponding one of the radiating elements 122.

The feeder circuit 110A includes switches 111A to 111D, 113A to 113D and 117, power amplifiers 112AT to 112DT, low-noise amplifiers 112AR to 112DR, attenuators 114A to 114D, phase shifters 115A to 115D, a signal multiplexer/demultiplexer 116, a mixer 118, and an amplifier circuit 119.

In a case where a radio frequency signal is sent, the switches 111A to 111D and 113A to 113D are switched over to the power amplifiers 112AT to 112DT, and the switch 117 is connected to an amplifier on the sending side of the amplifier circuit 119. In a case where a radio frequency signal is received, the switches 111A to 111D and 113A to 113D are switched over to the low-noise amplifiers 112AR to 112DR, and the switch 117 is connected to an amplifier on the reception side of the amplifier circuit 119.

The signal transmitted from the BBIC 200 is amplified by the amplifier circuit 119 and upconverted by the mixer 118. A sending signal that is an upconverted radio frequency signal is demultiplexed into four signals by the signal multiplexer/demultiplexer 116, and the four signals pass through four respective signal paths and are fed to respective different radiating elements 121. At this time, the directivity of the phase degrees of the phase shifters 115A to 115D disposed on the signal paths are individually controlled, and the antenna device 120 can thereby be controlled. The attenuators 114A to 114D control the strength of the sending signals.

Reception signals that are radio frequency signals received by the respective radiating elements 121 pass through four respective different signal paths and are multiplexed by the signal multiplexer/demultiplexer 116. The multiplexed reception signal is downconverted by the mixer 118, amplified by the amplifier circuit 119, and transmitted to the BBIC 200.

The configuration of each of the feeder circuits 110B to 110D is the same as the configuration of the feeder circuit 110A. For easier explanation, the illustration of detailed configuration of the feeder circuits 110B to 110D is omitted in FIG. 1.

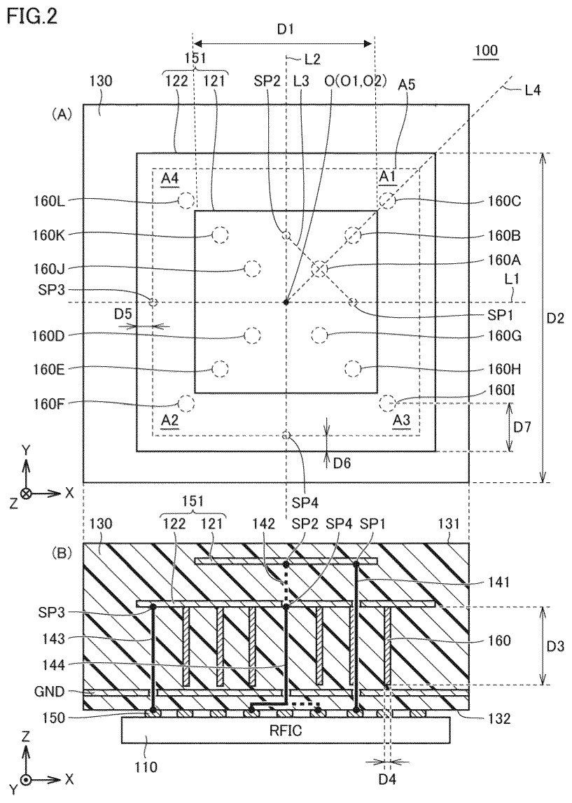

The RFIC 110 is formed, for example, as an integrated circuit component as one chip having the above-described circuit configuration. Alternatively, devices (a switch, a power amplifier, a low-noise amplifier, an attenuator, and a digital phase shifter) for each of the radiating elements 121 and 122 in the RFIC 110 may be formed as an integrated circuit component as one chip for the corresponding radiating element. In addition, although FIG. 1 illustrates the configuration in which the RFIC 110 is isolated from the antenna device 120, the RFIC 110 may be mounted on the dielectric substrate 130 having the corresponding radiating elements 121 and 122 disposed thereon, as to be described later with reference to FIG. 2 and the like, and thus may integrally form the antenna device 120.

### (Antenna Module Structure)

Details of the configuration of the antenna module 100 in Embodiment 1 will then be described with reference to FIG. 2. FIG. 2 illustrates a plan view (upper part) and a side perspective view (lower part) of the antenna module. In FIG. 2, for easier explanation, a configuration in which one of the antenna elements 151 is disposed on the dielectric substrate 130 will be described as an example.

The antenna module 100 includes a ground electrode GND, a plurality of feed wiring lines 141 to 144, and a plurality of metal members 160A to 160L, in addition to the antenna element 151 (radiating elements 121 and 122) and the RFIC 110. In the following description, a direction of the normal line of the ground electrode GND is a Z-axis direction, and a plane orthogonal to the normal direction is an XY plane. A positive direction and a negative direction along the Z axis in the drawings are respectively referred to as an upper side and a lower side on occasions. In FIG. 1, the feed wiring line 142 and the feed wiring line 144 overlap with each other, and thus the feed wiring line 142 is conveniently represented by using a broken line.

The dielectric substrate 130 is, for example, a low-temperature co-fired ceramic (LTCC) multi-layer substrate, a multi-layer resin substrate formed by laminating a plurality of resin layers formed from resin such as epoxy or polyimide, a multi-layer resin substrate formed by laminating a plurality of resin layers formed from liquid crystal polymer (LCP) having a lower dielectric constant, a multi-layer resin substrate formed by laminating a plurality of resin layers formed from fluorine-based resin, a multi-layer resin substrate formed by laminating a plurality of resin layers formed from a PET (Polyethylene Terephthalate) material, or a ceramic multi-layer substrate other than the LTCC. The dielectric substrate 130 does not necessarily have to have the multi-layer structure and may be a single-layer substrate.

In the antenna module 100, conductors forming the ground electrode GND, the feed wiring lines 141 to 144, the metal members 160A to 160L, and the like are formed from a metal, as a main component, that is aluminum (Al), copper (Cu), gold (Au), silver (Ag), or an alloy of any of these.

In plan view in the normal direction (Z-axis direction), the dielectric substrate 130 has a substantially rectangular shape. The radiating element 121 is disposed on a dielectric layer (dielectric layer on the upper side) close to an upper surface 131 (a surface in the positive direction along the Z axis) of the dielectric substrate 130. The radiating element 121 may be disposed in such a manner as to be exposed to the surface of the dielectric substrate 130 or may be disposed in a dielectric layer inside the dielectric substrate 130 as in FIG. 2.

The radiating element 122 is disposed in a dielectric layer closer to a lower surface 132 than to the radiating element 121 and faces the radiating element 121. The radiating element 122 extends further than the radiating element 121 in both directions of the XY plane. The ground electrode GND is disposed over more of the dielectric layer than the radiating element 122 in both directions of the XY plane, e.g., extends over an entirety of the dielectric layer. The ground electrode GND is closer to the lower surface 132 of the dielectric substrate 130 than to the radiating element 122 and faces the radiating elements 121 and 122. In plan view in a direction of the normal line of the ground electrode GND (Z-axis direction), the radiating elements 121 and 122 and the ground electrode GND overlap with each other. In particular, the radiating element 121 is completely overlapped by the radiating elements 122 and the ground electrode GND, and the radiating elements 122 is completely overlapped by the ground electrode GND. The radiating element 122 is thus disposed between the radiating element 121 and the ground electrode GND.

The radiating elements 121 and 122 are each a substantially rectangular plate-shaped electrode. More specifically, the radiating elements 121 and 122 each have a square shape in this particular embodiment. The radiating element 121 is disposed to superpose a center O1 of the radiating element 121 on a center O2 of the radiating element 122. Hereinafter, the center O1 and the center O2 are also simply referred to as a center O. The size of the radiating element 121 is smaller than the size of the radiating element 122, and the resonant frequency of the0 radiating element 121 is higher than the resonant frequency of the radiating element 122. The frequency band of a radio wave radiated from the radiating element 121 is higher than the frequency band of a radio wave radiated from the radiating element 122. More specifically, the frequency band of the radio wave radiated from the radiating element 121 is twice or more the frequency band of the radio wave radiated from the radiating element 122. For example, a 57-71 GHz radio wave is radiated from the radiating element 121, and a 24-28 GHz radio wave is radiated from the radiating element 122.

Radio frequency signals are individually supplied from the RFIC 110 to the radiating element 121 via the feed wiring lines 141 and 142. Radio frequency signals are individually supplied from the RFIC 110 to the radiating element 122 via the feed wiring lines 143 and 144.

The feed wiring line 141 is connected to a feed point SP1 of the radiating element 121, penetrating through the ground electrode GND and the radiating element 122 from the RFIC 110. The feed wiring line 142 is connected to a feed point SP2 of the radiating element 121, penetrating through the ground electrode GND and the radiating element 122 from the RFIC 110. The feed point SP1 is shifted from the center O1 of the radiating element 121 in a positive direction of an X axis, and the feed point SP2 is shifted from the center O1 of the radiating element 121 in a positive direction of a Y axis. This causes, to be radiated from the radiating element 121, radio waves in the X-axis direction and the Y-axis direction each serving as a polarization direction.

The feed wiring line 143 is connected to a feed point SP3 of the radiating element 122, penetrating through the ground electrode GND from the RFIC 110. The feed wiring line 144 is connected to a feed point SP4 of the radiating element 122, penetrating through the ground electrode GND from the RFIC 110. The feed point SP3 is shifted from the center O2 of the radiating element 122 in a negative direction along the X axis, and the feed point SP4 is shifted from the center O2 of the radiating element 122 in a negative direction along the Y axis. This causes, to be radiated from the radiating element 122, radio waves in the X-axis direction and the Y-axis direction each serving as a polarization direction.

In plan view in the normal direction of the ground electrode GND (Z-axis direction) and with respect to the center O, the feed point SP1 and the feed point SP3 are disposed opposite each other along the X axis, and the feed point SP2 and the feed point SP4 are disposed opposite each other along the Y axis.

For the radio wave radiated from the radiating element 121 in the X-axis direction serving as the polarization direction, a length D1 of a side, in the X-axis direction, of the radiating element 121 is about λg/2 where an intra-substrate wavelength in consideration of the dielectric constant of the dielectric substrate 130 is λg. Since the radiating element 121 has the square shape, a length D2 of a side, in the Y-axis direction, of the radiating element 121 is identical to the length D1. Regarding the radiating element 121, the frequency band of the radio wave in the X-axis direction serving as the polarization direction and the frequency band of the radio wave in the Y-axis direction serving as the polarization direction are thus identical. It can be said that the length D1 of the side, in the X-axis direction, of the radiating element 121 is the length of the radiating element 121 in the X-axis direction. It can also be said that the length D2 of the side, in the Y-axis direction, of the radiating element 121 is the length of the radiating element 121 in the Y-axis direction.

The radiating element 122 has a square shape. Regarding the radiating element 122, like the radiating element 121, the frequency band of the radio wave in the X-axis direction serving as the polarization direction and the frequency band of the radio wave in the Y-axis direction serving as the polarization direction are thus identical.

As described above, the antenna module 100 is the dual-band-type antenna module with the stack structure and is also the dual-polarization-type antenna module.

The RFIC 110 is mounted on the lower surface 132 of the dielectric substrate 130 with solder bumps 150 interposed therebetween. The RFIC 110 may be connected to the dielectric substrate 130 by using multipole connectors, instead of the soldering connection.

The plurality of metal members 160A to 160L are each disposed in such a manner as to extend from the radiating element 122 in the normal direction of the ground electrode GND (Z-axis direction), not to come in contact with the ground electrode GND. More specifically, the plurality of metal members 160A to 160L are each connected to the bottom surface of the radiating element 122 (surface in a negative direction along the Z axis) are spaced apart from each other in the XY plane, e.g., evenly spaced, and are disposed to extend in the direction toward the ground electrode GND (negative direction along the Z axis). When not being discriminated therebetween, the metal members 160A to 160L are hereinafter referred to as metal members 160.

Each metal member 160 has a long and narrow cylindrical columnar shape. A length D3, in the Z-axis direction, of the metal member 160 is half the length D1 of the side of the radiating element 121. Since the length D1 and the length D2 of the radiating element 121 are identical, it can be said that the length D3 of the metal member 160 is half the length D2 of the radiating element 121. The lengths D1 and D2 of the radiating element 121 are about λg/2, and thus the length D3 of the metal member 160 is about λg/4, where the intra-substrate wavelength of the radio wave radiated from the radiating element 121 is λg. Even if the metal members have another shape such as an L shape or an S shape, the metal members are designed such that the length, in the extending direction, of each metal member is half each of the lengths D1 and D2 of the sides of the radiating element 121. It thus suffices that the metal member is designed such that the length, in the extending direction, of the metal member is half each of the lengths D1 and D2 of the sides of the radiating element 121.

A thickness D4 of the metal member 160 may be one-tenth or less of the length D1 of the side of the radiating element 121. The length D1 and the length D2 of the radiating element 121 are identical, and thus it can also be said that the thickness D4 of the metal member 160 is one-tenth or less of the length D2 of the radiating element 121. The thickness D4 of the metal member 160 is λg/20 or less, where the intra-substrate wavelength of the radio wave radiated from the radiating element 121 is λg. The metal member 160 is thus designed such that the maximum dimension is one-tenth or less of each of the lengths D1 and D2 of the sides of the radiating element 121 on a cross section orthogonal to the extending direction of the metal member 160.

The shape of the metal member 160 is not limited to the columnar shape. For example, the metal member 160 may have a quadrangular prism shape or a polygonal columnar shape or may have a hollow structure. Also in the case as described above, it suffices that the metal member is designed such that the length in the extending direction of the metal member is half each of the lengths D1 and D2 of the sides of the radiating element 121. It also suffices that the metal member is designed such that the maximum dimension is one-tenth or less of the length of the side of the radiating element 121 on the cross section orthogonal to the extending direction of the metal member 160.

### (Metal Member Disposition Layout)

In the antenna module 100 in Embodiment 1, the metal members 160 the number of which is 12 (=4×3) are disposed on the radiating element 122. More specifically, in plan view in the normal direction of the ground electrode GND, the radiating element 122 is divided into four areas A1 to A4 by using a straight line L1 connecting the feed point SP1 and the feed point SP3 and a straight line L2 connecting the feed point SP2 and the feed point SP4. The metal members 160 the number of which is 3 are disposed in each of the four areas A1 to A4.

The area A1 is an area defined by a side passing through the feed point SP1 and a side passing through the feed point SP2. The area A2 is located in point symmetry with the area A1 with respect to the center O. The area A3 is located adjacent to the area A1 across the straight line L1. The area A4 is located adjacent to the area A1 across the straight line L2.

In plan view in the normal direction of the ground electrode GND, the metal members 160A to 160C disposed in the area A1 are connected on a perpendicular bisector L4 of a straight line L3 connecting the feed point SP1 and the feed point SP2. The metal members 160A to 160C are thus each disposed to cause, to be identical, a distance from a point of connection of the corresponding metal member 160 to the feed point SP1 and a distance from the point of connection of the metal member 160 to the feed point SP2.

In plan view in the normal direction of the ground electrode GND, the metal members 160A to 160C disposed in the area A1 and the metal members 160D to 160F disposed in the area A2 have a relationship of point symmetry with respect to the center O. In plan view in the normal direction of the ground electrode GND, the metal members 160G to 160I disposed in the area A3 and the metal members 160J to 160L disposed in the area A3 have a relationship of point symmetry with respect to the center O.

In plan view in the normal direction of the ground electrode GND, the metal members 160A to 160C disposed in the area A1 and the metal members 160G to 160I disposed in the area A3 have a relationship of line symmetry with respect to the straight line L1. The metal members 160A to 160C disposed in the area A1 and the metal members 160J to 160L disposed in the area A4 have a relationship of line symmetry with respect to the straight line L2. Disposing in this manner causes the metal members 160A to 160C to be disposed on the perpendicular bisector L4 and thus causes the metal members 160A to 160L to be arranged in an X shape in plan view in the normal direction of the ground electrode GND. For example, each of the four areas may each have n metal members 160, with a total number of metal members being 4n ((n≥1).

The plurality of metal members 160A to 160L are each disposed at a position excluding the outer circumference and the center O of the radiating element 122. More specifically, in plan view in the normal direction of the ground electrode GND, the plurality of metal members 160A to 160L are each disposed to cause the shortest distance from the point of connection of the corresponding metal member 160 to an end portion of the radiating element 122 to be longer than a shortest distance D5 from the feed point SP3 to the end portion of the radiating element 122. The plurality of metal members 160A to 160L are each disposed to cause the shortest distance from the point of connection of the corresponding metal member 160 to an end portion of the radiating element 122 to be longer than a shortest distance D6 from the feed point SP4 to the end portion of the radiating element 122.

In an example, a shortest distance D7 from the point of connection of the metal member 160I to an end portion of the radiating element 122 is longer than any of the shortest distance D5 and the shortest distance D6. For example, assume that an area A5 is defined on the radiating element 122 in plan view in the normal direction of the ground electrode GND. The area A5 is a square area where the length, in the Y axis, of the side is twice the distance from the center O2 to the feed point SP3 and the length, in the X axis, of the side is twice the distance from the center O2 to the feed point SP4 and is also an area defined to superpose the center of the square on the center O. In this case, it can be said that the plurality of metal members 160A to 160L are each connected in the area A5 in plan view in the normal direction of the ground electrode GND.

### (Antenna Characteristics)

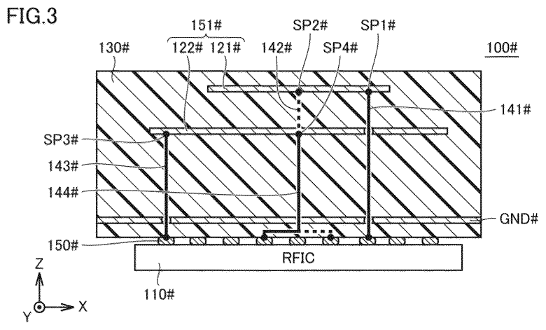

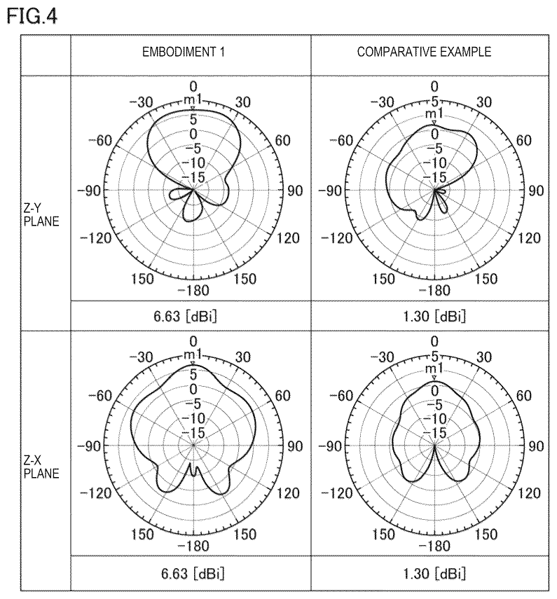

The antenna characteristics of the antenna module 100 in Embodiment 1 will then be described by using FIGS. 3 to 5 as compared with a comparative example. FIG. 3 is a side perspective view of an antenna module in the comparative example. FIG. 4 is a view illustrating simulation results of antenna gains. FIG. 5 is a graph illustrating simulation results of isolation characteristics. The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

An antenna module 100 # in the comparative example has the same structure as that of the antenna module 100 in Embodiment 1 except a point that the antenna module 100 # does not include the metal members 160. In FIG. 3, # is suffixed to components having the same function as that in the antenna module 100 in Embodiment 1. The antenna module 100 # is configured such that a wavelength with a lower frequency is twice or more a wavelength with a higher frequency. The simulation results illustrated in FIGS. 4 and 5 are each a simulation result of a radio wave with a higher frequency in the X-axis direction serving as the polarization direction in a case where radio frequency signals are supplied to the feed point SP1 and a feed point SP1 # of the radiating element 121 and a radiating element 121 # for higher frequencies.

Antenna gains illustrated in the upper part of FIG. 4 are peak gains at angles to the radiating direction (Z-axis direction) on Z-Y planes each having the plane center (center O1) of a corresponding one of the radiating elements 121 and 121 #, the plane center serving as the origin. The antenna gains illustrated in the lower part of FIG. 4 are peak gains at angles to the radiating direction (Z-axis direction) on Z-X planes each having the plane center (center O1) of a corresponding one of the radiating elements 121 and 121 #, the plane center serving as the origin.

As illustrated in FIG. 4, in the antenna module 100 # in the comparative example not including the metal members 160, the total peak gain is 1.30 [dBi]. In contrast, in the antenna module 100 in Embodiment 1 including the metal member 160, the total peak gain is improved to 6.63 [dBi].

As represented by the simulation results in the comparative example, if a wavelength with a lower frequency is twice or more a wavelength with a higher frequency in the dual-band-type antenna module with the stack structure, the antenna gain (gain) in the radiating direction (Z-axis direction) is decreased. This is attributed to the following. The wavelength with the lower frequency is twice or more the wavelength with the higher frequency, and a feed wiring line 141 # penetrates through a radiating element 122 # for the lower frequency. The feed wiring line 141 and the radiating element 122 # are thereby electrically coupled together, and the radiating element 122 # resonates in a higher-order mode.

In the antenna module 100 in Embodiment 1, the metal members 160 cause weaker electrical coupling between the feed wiring line 141 (or the feed wiring line 142) and the radiating element 122, which can prevent the radiating element 122 from resonating in the higher-order mode. The antenna gain is thus improved.

Since there is zero electric field at the center O of the radiating element 121, disposing each metal member 160 at the position excluding the center O causes weaker electrical coupling between the feed wiring line 141 (or the feed wiring line 142) and the radiating element 122, and thus the radiating element 122 may be prevented from resonating in the higher-order mode.

In Embodiment 1, the length in the extending direction of the metal member 160 is half the length of the side of the radiating element 121. In other words, the length is about one-fourth of the intra-substrate wavelength λg of the radio wave radiated from the radiating element 121. The thickness D4 of the metal member 160 is one-tenth or less of the length of the radiating element 121. In other words, the thickness D4 is about one-twentieth of the intra-substrate wavelength λg of the radio wave radiated from the radiating element 121 and thus is sufficiently thin. The metal member 160 thus functions as a resonant member, and the radiating element 121 may be prevented from resonating in the higher-order mode. The metal member 160 is not electrically connected to the ground electrode GND and thus is difficult to function as an antenna. It is thus less likely to hinder the radio wave from radiating in the radiating direction (Z-axis direction). In Embodiment 1, the radiating element 121 is the substantially rectangular plate-shaped electrode. Even if the radiating element 121 has another shape, the metal member 160 may have dimensions that cause the metal member 160 to function as a resonant member appropriately for the shape of the radiating element 121 when a radio frequency signal is supplied to the radiating element 121.

In FIG. 5, a solid line SL represents a characteristic of isolation between a feed path for the feed point SP1 and a feed path for the feed point SP2 in Embodiment 1, and a broken line DL represents a characteristic of isolation between a feed path for the feed point SP1 # and a feed path for a feed point SP2 # in the comparative example. As illustrated in FIG. 5, isolation around 60 GHz that is the operating band of the radiating element 121 of the antenna module 100 is improved in Embodiment 1 as compared with the comparative example. In the antenna module 100 in Embodiment 1 as illustrated in FIG. 2, the metal members 160A to 160C are disposed between the feed point SP1 and the feed point SP2. As the result, each metal member 160 serves as a barrier, the occurrence of electrical coupling between the two feed points SP1 and SP2 may be reduced, and the isolation characteristic may be improved.

In the antenna module 100 in Embodiment 1 as described above, the same number of metal members 160 are disposed in each of the four areas A1 to A4. Accordingly, the influence of the metal members 160 may be exerted evenly on the whole radiation surface (XY plane) of the radiating element 121, and radiation pattern disturbance may be prevented.

The metal members 160 disposed in each of the four areas A1 to A4 are disposed in point symmetry with respect to the center O. Accordingly, the configuration as described above also enables the influence of the metal member 160 to be exerted evenly on the whole radiation surface (XY plane) of the radiating element 121 and enables radiation pattern disturbance to be prevented.

Disposing the metal members 160 between the feed point SP1 and the feed point SP2 and disposing the metal members 160 in each of the four areas A1 to A4 in point symmetry with respect to the center O cause the metal members 160A to 160L to be arranged in the X shape. Accordingly, arranging the metal members 160 in the X shape enables the isolation characteristic to be improved and also enables the radiation pattern disturbance to be prevented.

When a radio frequency signal is supplied to the radiating element 122, stronger electromagnetic fields are distributed along the outer circumference of the radiating element 122 than in the center of the radiating element 122. In Embodiment 1, the metal members 160 are connected in the area A5 excluding the outer circumference of the radiating element 122. If the metal members 160 are disposed in an area where strong electromagnetic fields are distributed, there is a possibility of hindering the function of the radiating element 122 as an antenna. In Embodiment 1, disposing the metal members 160 to avoid the area as described above enables the antenna gain of the radiating element 121 to be improved without hindering the function of the radiating element 122 as an antenna.

As described above, the electrical coupling between the feed wiring line 141 (or the feed wiring line 142) and the radiating element 122 is weakened, and thereby the metal members 160 cause the antenna gain of the radiating element 121 to be improved. The metal members 160 may thus be disposed near the feed wiring line 141 (or the feed wiring line 142). On the other hand, in consideration of the influence on the antenna characteristic of the radiating element 122, a small number of metal members 160 may be disposed on the radiating element 122.

The antenna module 100 in Embodiment 1 is the dual-band-type and dual-polarization-type antenna module, and the two feed wiring lines 141 and 142 penetrate through the radiating element 122. Individually disposing the metal members 160 near both of the feed wiring line 141 and the feed wiring line 142 leads an increase in the number of disposed metal members 160. In the antenna module 100 in Embodiment 1, the metal members 160A to 160C are each disposed on the perpendicular bisector L4 of the straight line L3 connecting the feed point SP1 and the feed point SP2 and thus are disposed to cause, to be identical, the distance from the feed point SP1 to the corresponding metal member 160 and the distance from the feed point SP2 to the metal member 160. As the result, the number of metal members 160 to be disposed on the radiating element 122 may be reduced. In addition, if a radio frequency signal is supplied to any of the feed point SP1 and the feed point SP2, the antenna gain of the radiating element 121 may likewise be improved.

The metal members 160 are disposed to cause, to be identical, the distance from the feed point SP1 to the metal member 160 and the distance from the feed point SP2 to the metal member 160, and thereby the antenna gains may be improved evenly for both of radio waves in different polarization directions that are allowed to be radiated from the radiating element 121.

As described above, the antenna module 100 in Embodiment 1 includes the metal members 160, and the antenna gain of the radiating element 121 may thereby be improved.

The ground electrode GND, the radiating element 121, the radiating element 122, and each metal member 160 in Embodiment 1 respectively correspond to a ground electrode, a first radiating element, a second radiating element, and a first metal member in the present disclosure. In Embodiment 1, the feed wiring lines 141 and 142 respectively correspond to a first feed wiring line and a second feed wiring line of the present disclosure, and the feed wiring lines 143 and 144 respectively correspond to a third feed wiring line and a fourth feed wiring line of the present disclosure. In Embodiment 1, the feed points SP1 and SP2 respectively correspond to a first feed point and a second feed point of the present disclosure, and the feed points SP3 and SP4 respectively correspond to a third feed point and a fourth feed point of the present disclosure.

In Embodiment 1, the positive direction along the Y axis and the negative direction along the Y axis respectively correspond to a first direction and a fourth direction of the present disclosure, and the negative direction along the X axis and the positive direction along the X axis respectively correspond to a second direction and a third direction of the present disclosure. The areas A1, A2, A3, and A4 in the present disclosure respectively correspond to a first area, a second area, a third area, and a fourth area of the present disclosure.

### Modifications 1 and 2

For the antenna module 100 in Embodiment 1, the configuration in which the plurality of metal members 160A to 160L are included and the metal members 160A to 160L are arranged in the X shape has been described.

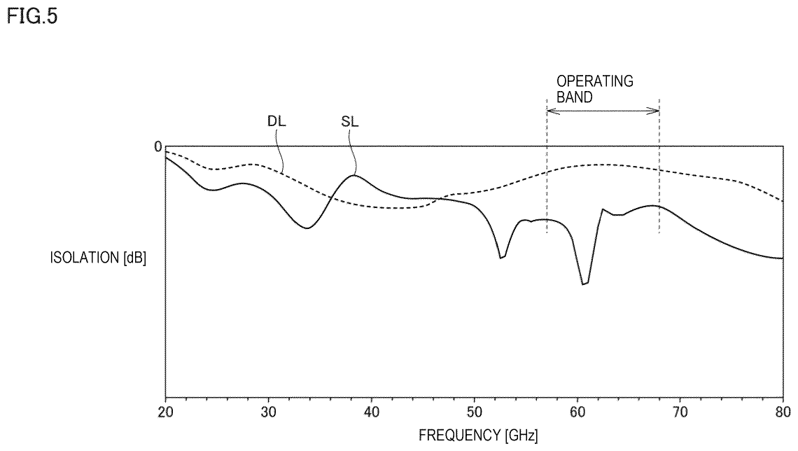

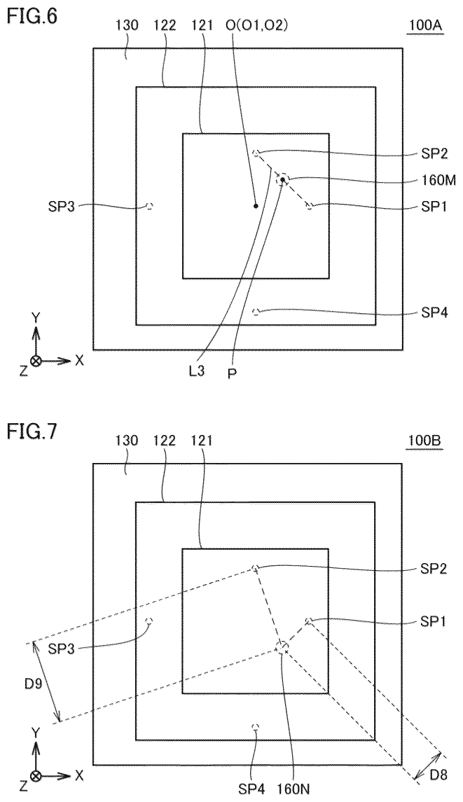

For Modifications 1 and 2, examples where an antenna module has one metal member will be described. FIG. 6 is a plan view of an antenna module in Modification 1. FIG. 7 is a plan view of an antenna module in Modification 2. An antenna module 100A in Modification 1 and an antenna module 100B in Modification 2 each have the radiating element 121 and the radiating element 122 in structure common to those of the antenna module 100 in Embodiment 1 and are different from the antenna module 100 in a point that only one metal member 160 is included. With reference to FIGS. 6 and 7, explanation of components overlapping with the explanation with reference to FIG. 2 is not repeated.

The antenna module 100A includes one metal member 160M. In plan view in the normal direction of the ground electrode GND, the metal member 160M is disposed to cause, to be identical, a distance from the metal member 160M to the feed point SP1 and a distance from the metal member 160M to the feed point SP2. More specifically, in plan view in the normal direction of the ground electrode GND, the metal member 160M is connected at a middle point P of the straight line L3 connecting the feed point SP1 and the feed point SP2.

The antenna module 100B includes one metal member 160N. In plan view in the normal direction of the ground electrode GND, the metal member 160N is disposed to cause a distance D8 from the point of connection to the metal member 160N to the feed point SP1 to be shorter than a distance D9 from the point of connection to the metal member 160N to the feed point SP2. As compared with the antenna module 100A and the antenna module 100B, the distance D8 from the point of connection to the metal member 160N to the feed point SP1 is shorter than the distance from the point of connection to the metal member 160M to the feed point SP1.

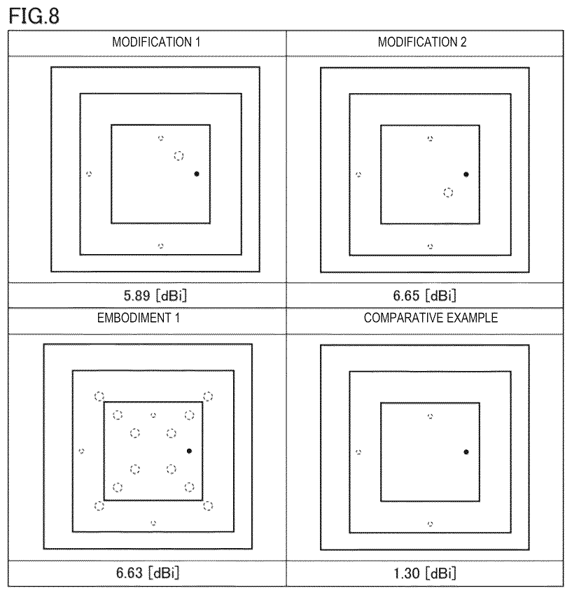

FIG. 8 is a view illustrating simulation results of antenna gains. FIG. 8 illustrates only total peak gains. FIG. 8 also illustrates simulation results in the antenna module 100 in Embodiment 1 and the antenna module 100 # in the comparative example for reference and plan views of the antenna modules. Each simulation result illustrated in FIG. 8 represents a result at the time of supplying a radio frequency signal to the feed point SP1. In FIG. 8, feed points supplied with radio frequency signals are represented by using black dots conveniently.

As illustrated in FIG. 8, in each of the antenna modules 100A and 100B having the one metal member, the antenna gain has been improved as compared with the comparative example. That is, if the antenna module includes at least one metal member, the antenna gain may be improved. The distance to the feed point SP1 supplied with the radio frequency signal is shorter in the metal member 160N than in the metal member 160M. As illustrated in FIG. 8, in the antenna module 100B where the metal member is disposed closer to the feed point SP1 supplied with the radio frequency signal, the antenna gain has been improved as compared with the antenna module 100A. It is thus understood that antenna gain improvement is expected from a shorter distance between the metal member and a feed wiring line.

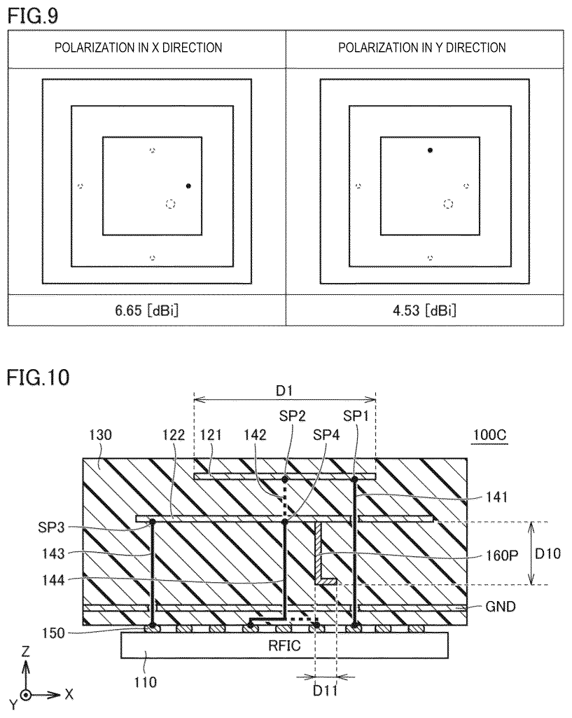

FIG. 9 is a view illustrating simulation results of antenna gains, in polarization directions, of radio waves in the antenna module in Modification 2. In FIG. 9, feed points supplied with radio frequency signals are represented by using black dots conveniently.

In the antenna module 100B, as compared with a radio wave radiated and supplying a radio frequency signal to the feed point SP2, the antenna gain has been improved in a radio wave radiated and supplying a radio frequency signal to the feed point SP1 in a shorter distance to the metal member 160N. Also from the simulation results illustrated in FIG. 9, it is understood that antenna gain improvement is expected from a shorter distance between a metal member and a feed wiring line.

Disposing the metal member 160M at the middle point P of the straight line L3 connecting the feed point SP1 and the feed point SP2 as in the antenna module 100A in Modification 1 enables the metal member 160M to be disposed near each of the feed wiring line 141 extending to the feed point SP1 and the feed wiring line 142 extending to the feed point SP2. As the result, the antenna gain may be improved equally for both of the two radio waves radiated from the radiating element 121 in the mutually different polarization directions, and the occurrence of unbalanced antenna gains in the two radio waves may be prevented.

Referring back to FIG. 8, the antenna module 100 in Embodiment 1 has improved antenna gain as compared with the antenna module 100A in Modification 1. From the simulation results illustrated in FIG. 8, it is understood that the antenna gain improvement is expected from the inclusion of the plurality of metal members 160. The inclusion of the plurality of metal members 160 thus enables the antenna gain to be improved further.

The distance from the feed point SP1 to the middle point P and the distance from the feed point SP2 to the middle point P in Modification 1 respectively correspond to the first distance and the second distance in the present disclosure.

### Modifications 3 to 5

Variations in the position, the dimensions, and the shape of at least one metal member 160 disposed on the radiating element 122 will then be described by using FIGS. 10 to 12. With reference to FIGS. 10 to 12, explanation of components overlapping with the explanation with reference to FIG. 2 is not repeated.

### (a) Modification 3

FIG. 10 is a side perspective view of an antenna module in Modification 3. An antenna module 100C in Modification 3 includes a metal member 160P of a bent shape. As illustrated in FIG. 10, the metal member may have a shape bent in an L shape. As described above, even in this case, the length, in the extending direction, of the metal member 160P (=D10+D11) is may be designed to be half the length D1 of the side of the radiating element 121.

### (b) Modification 4

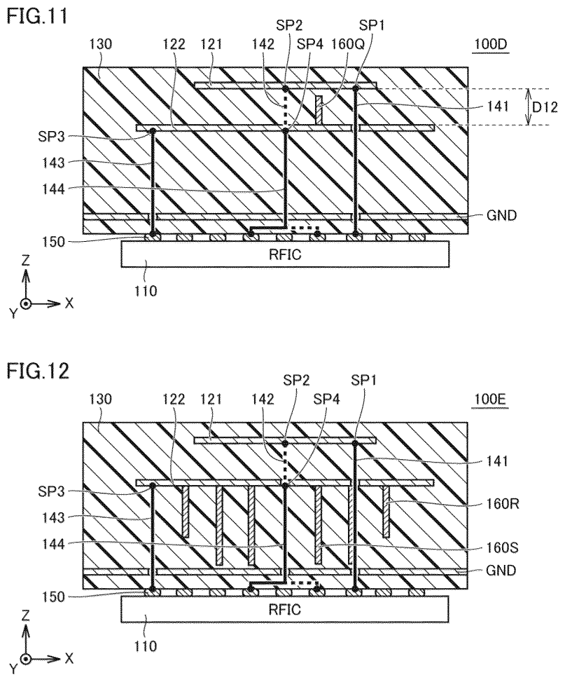

FIG. 11 is a side perspective view of an antenna module in Modification 4. An antenna module 100D in Modification 4 includes a metal member 160Q disposed to extend in a direction from the radiating element 122 toward the radiating element 121 (positive direction along the Z axis). In the configuration as described above, the length, in a direction of the normal line, of the metal member 160Q may be shorter than an inter-element distance D12 between the radiating element 121 and the radiating element 122 in a direction of the normal line of the dielectric substrate 130. Designing as described above causes radiant efficiency of the radiating element 121 to be prevented from decreasing. The length, in the extending direction, of the metal member 160Q may be about one-fourth of the intra-substrate wavelength λg of a radio wave radiated from the radiating element 121. Such control may be realized without other considerations, such as forming the metal member into the L shape, or setting the sufficient inter-element distance D12.

Accordingly, disposing the metal member 160 to extend in the direction from the radiating element 122 toward the ground electrode GND (negative direction along the Z axis) as in the antenna module 100 in Embodiment 1 leads to improvement in the degree of freedom in designing the metal member 160. A decrease in the radiant efficiency of the radiating element 121 may also be prevented.

### (c) Modification 5

FIG. 12 is a side perspective view of an antenna module in Modification 5. An antenna module 100E in Modification 5 includes a plurality of metal members 160R and 160S, and the length of the metal members 160R and the length of the metal members 160S are different from each other. As described above, the length, in the extending direction, of each metal member 160 is about one-fourth of the intra-substrate wavelength λg of a radio wave radiated from the radiating element 121, and thereby the metal member 160 functions as a resonant member. The frequency of the radio wave radiated from the radiating element 121 has a range to some extent. Inclusion of the plurality of metal members 160R and 160S with different lengths enables improvement in the antenna gains of the whole frequency band in the range for the radiation from the radiating element 121. For example, metal members 160S that are longer than metal members 160R may be closer to the center O.

The metal member 160R and the metal member 160S in Modification 5 respectively correspond to a first member and a second member in the present disclosure.

### Embodiment 2

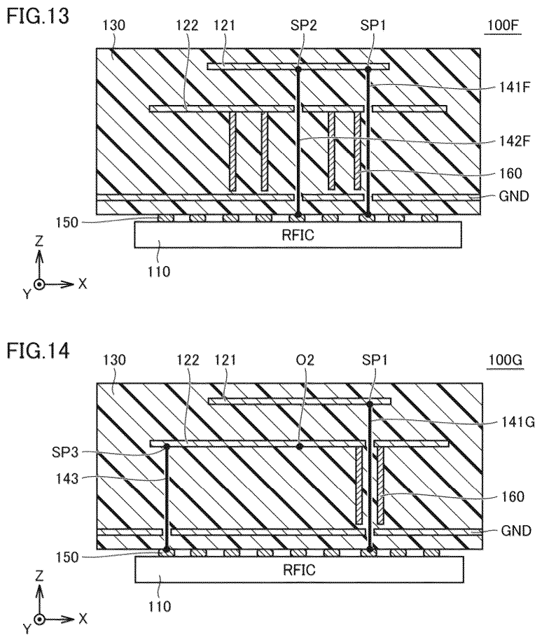

FIG. 13 is a side perspective view of an antenna module in Embodiment 2. For the antenna module 100 in Embodiment 1, the configuration in which radio frequency signals are supplied to the radiating element 121 and the radiating element 122 by using the individual feed wiring lines has been described.

The features according to the present disclosure may be applied to a configuration in which the radiating elements 121 and 122 share a feed wiring line. In an antenna module 100F in Embodiment 2, the radiating elements 121 and 122 share feed wiring lines. The antenna module 100F includes feed wiring lines 141F and 142F. The feed wiring line 141F is connected to the feed point SP1 of the radiating element 121, penetrating through the ground electrode GND and the radiating element 122 from the RFIC 110. The feed wiring line 142F is connected to the feed point SP2 of the radiating element 121, penetrating through the ground electrode GND and the radiating element 122 from the RFIC 110.

In response to a radio frequency signal for the radiating element 121 being supplied to the feed wiring line 141F, the radio frequency signal is supplied to the radiating element 121; however, disposing the metal members 160 on the radiating element 122 enables the radiating element 122 to be prevented from resonating in the higher-order mode. As shown in FIG. 13, the metal members 160 may be provided only near the center O, e.g., may be on either side of the feed wiring line 142F, but only on one side of the feed wiring line 141F. The feed wiring line 141F and the radiating element 122 are electrically coupled at the through hole portion of the radiating element 122, and a radio frequency signal for the radiating element 122 is supplied to the radiating element 122. Likewise, in the feed wiring line 142F, a radio frequency signal is supplied to the radiating element 122 in response to the radio frequency signal for the radiating element 122 being supplied, and a radio frequency signal is supplied to the radiating element 121 in response to the radio frequency signal for the radiating element 121 being supplied.

Note that the length of each metal member 160 is not about one-fourth of an intra-substrate wavelength Δg2 of the radio wave radiated from the radiating element 122. Accordingly, even if the radio frequency signal for the radiating element 122 is supplied to the feed wiring line 141F, the metal member 160 does not function as a resonant member. Sharing the feed wiring lines by the radiating elements 121 and 122 enables the feed wiring line structure to be simplified. On the other hand, sharing the feed wiring lines causes the radiating element 122 to resonate in the higher-order mode easily and also causes the antenna gain of the radiating element 121 to be decreased easily. Also in the antenna module 100F in Embodiment 2, like the antenna module 100 in Embodiment 1, disposing the metal member 160 on the radiating element 122 enables the radiating element 122 to be prevented from resonating in the higher-order mode. As the result, the antenna gain of the radiating element 121 is improved.

### Embodiment 3

FIG. 14 is a side perspective view of an antenna module in Embodiment 3. The antenna module 100 in Embodiment 1 is an antenna module of the dual polarization type. The features according to the present disclosure may be applied to an antenna module of a single polarization type.

An antenna module 100G in Embodiment 3 is an antenna module of a single polarization type. The antenna module 100G is different from the antenna module 100 in Embodiment 1 in points that: the feed wiring line 142 and the feed wiring line 144 are not included; a feed wiring line 141G is included instead of the feed wiring line 141; and the positions of the metal members 160 are different.

The antenna module 100G includes the feed wiring line 141G the number of which is 1, that supplies a radio frequency signal to the radiating element 121, and that penetrates through the radiating element 122. A feed wiring line that penetrates through the radiating element 122 is thus limited to the feed wiring line 141G. For this reason, each metal member 160 may be as close to the feed wiring line 141G as possible, e.g., two metal members 160 may be provided, i.e., one metal member 160 on opposing sides of the feeding wire line 141G.

In the antenna module 100G, the metal member 160 disposed to be located near the feed wiring line 141G. Also in the antenna module 100G in Embodiment 3, like the antenna module 100 in Embodiment 1, disposing the metal member 160 on the radiating element 122 enables the radiating element 122 to be prevented from resonating in the higher-order mode, and as the result, the antenna gain of the radiating element 121 is improved. Further, disposing the metal member 160 near the feed wiring line 141G causes the antenna gain of the radiating element 121 to be improved effectively. The metal member 160 is disposed at the position excluding the outer circumference and the center O2 of the radiating element 122. As the result, the antenna gain of the radiating element 121 is improved without hindering the function of the radiating element 122 as an antenna.

### Embodiment 4

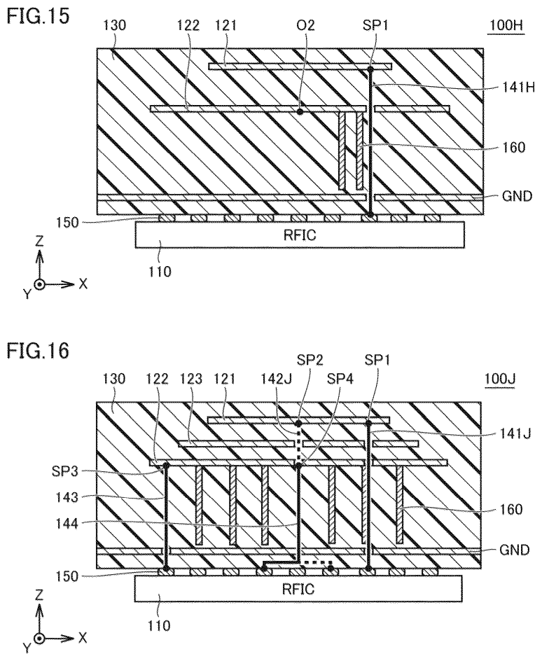

FIG. 15 is a side perspective view of an antenna module in Embodiment 4. An antenna module 100H in Embodiment 4 is an antenna module of a single polarization type and has a configuration in which the radiating elements 121 and 122 share a feed wiring line. The antenna module 100H is different from the antenna module 100 in Embodiment 1 in points that: the feed wiring line 142 to the feed wiring line 144 are not included; a feed wiring line 141H is included instead of the feed wiring line 141; and the positions of the metal members 160 are different.

In the antenna module 100H, a feed wiring line that penetrates through the radiating element 122 is limited to the feed wiring line 141H. For this reason, each metal member 160 may be as close to the feed wiring line 141H as possible.

In the antenna module 100H, the metal member 160 is disposed to be located near the feed wiring line 141H. Also in the antenna module 100H in Embodiment 4, like the antenna module 100 in Embodiment 1, disposing the metal member 160 on the radiating element 122 enables the radiating element 122 to be prevented from resonating in the higher-order mode, and as the result, the antenna gain of the radiating element 121 is improved. Further, disposing the metal member 160 near the feed wiring line 141H causes the antenna gain of the radiating element 121 to be improved effectively. The metal member 160 is also disposed at a position excluding the outer circumference and the center O2 of the radiating element 122, e.g., two metal members may be provided between the center O2 of the radiating element 122 and the feed wiring line 141H, both of which are closer to the feed wiring line 141H than to the center O2, and may be on only one side of the center O2. As the result, the antenna gain of the radiating element 121 is improved without hindering the function of the radiating element 122 as an antenna.

### Embodiment 5

FIG. 16 is a side perspective view of an antenna module in Embodiment 5. In FIG. 16, a feed wiring line 142J and the feed wiring line 144 overlap with each other, and thus the feed wiring line 142J is conveniently represented by using a broken line. An antenna module 100J in Embodiment 5 includes three radiating elements that are the radiating elements 121 and 122 and a radiating element 123. The antenna module 100J is thus an antenna module of a triple band type. The features according to the present disclosure may be applied to an antenna module of the triple band type. The antenna module 100J is different from the antenna module 100 in a point that the radiating element 123 is disposed between the radiating element 121 and the radiating element 122, the radiating element 123 being larger than the radiating element 121 in size and smaller than the radiating element 122 in size.

The configuration of the feed wiring lines is not particularly limited; however, for example, the antenna module 100J has the radiating elements 121 and 123 that share the feed wiring line 141J and the feed wiring line 142J. More specifically, the feed wiring line 141J is connected to the feed point SP1 of the radiating element 121, penetrating through the ground electrode GND, the radiating element 122, and the radiating element 123 from the RFIC 110. The feed wiring line 142J is connected to the feed point SP2 of the radiating element 121, penetrating through the ground electrode GND, the radiating element 122, and the radiating element 123 from the RFIC 110.

The antenna module 100J is configured to radiate radio waves, for example, with center frequencies of 28 GHz, 39 GHz, and 60 GHz. Specifically, a radio wave with the center frequency of 60 GHz is radiated from the radiating element 121, a radio wave with the center frequency of 39 GHz is radiated from the radiating element 123, and a radio wave with the center frequency of 28 GHz is radiated from the radiating element 122.

The frequency band of the radio wave radiated from the radiating element 121 is less than twice the frequency band of the radio wave radiated from the radiating element 123. For this reason, although each of the feed wiring line 141J and 142J penetrates through the radiating element 123, there is not a possibility that even if a radio frequency signal is supplied to the radiating element 121, the radiating element 123 resonates.

On the other hand, the frequency band of the radio wave radiated from the radiating element 121 is twice or more the frequency band of the radio wave radiated from the radiating element 122. For this reason, there is a possibility that if a radio frequency signal is supplied to the radiating element 121, the radiating element 122 resonates in the higher-order mode.

The frequency band of the radio wave radiated from the radiating element 121 is less than twice the frequency band of the radio wave radiated from the radiating element 123. Accordingly, any metal member 160 is not disposed on the radiating element 123 in the antenna module 100J. In contrast, the frequency band of the radio wave radiated from the radiating element 121 is twice or more the frequency band of the radio wave radiated from the radiating element 122. Accordingly, the metal members 160 are disposed on the radiating element 122. As the result, the radiating element 122 may be prevented from resonating in the higher-order mode, and thus the antenna gain is improved.

As described above, also in the antenna module 100J of the triple band type, disposing the metal members 160 on the radiating element 122 enables the radiating element 122 to be prevented from resonating in the higher-order mode, and thus the antenna gain is improved.

The radiating elements 121, 122, and 123 in Embodiment 5 respectively correspond to the first radiating element, the second radiating element, and a third radiating element in the present disclosure. The feed wiring line 141J in Embodiment 1 corresponds to the first feed wiring line in the present disclosure.

### Embodiment 6

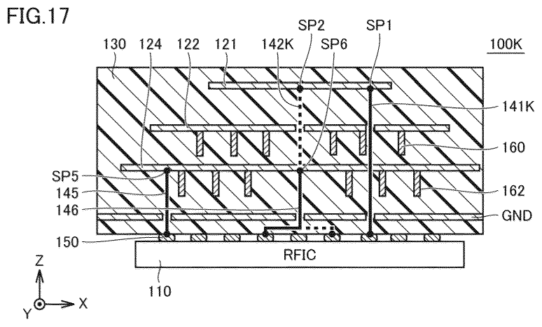

FIG. 17 is a side perspective view of an antenna module in Embodiment 6. An antenna module 100K in Embodiment 6 is different from the antenna module 100 in a point that a radiating element 124 is included between the radiating element 122 and the ground electrode GND, the radiating element 124 being larger in size in plan view than any radiating element of the radiating element 121 and the radiating element 122.

Although the configuration of the feed wiring lines is not particularly limited; however, for example, the antenna module 100K has the radiating elements 121 and 122 that share feed wiring lines 141K and 142K. More specifically, the feed wiring line 141K is connected to the feed point SP1 of the radiating element 121, penetrating through the ground electrode GND, the radiating element 123, and the radiating element 122 from the RFIC 110. The feed wiring line 142K is connected to the feed point SP2 of the radiating element 121, penetrating through the ground electrode GND, the radiating element 123, and the radiating element 122 from the RFIC 110.

The antenna module 100K further includes a feed wiring line 145 and a feed wiring line 146. The feed wiring line 145 is connected to a feed point SP5 of the radiating element 124, penetrating through the ground electrode GND from the RFIC 110. The feed wiring line 146 is connected to a feed point SP6 of the radiating element 124, penetrating through the ground electrode GND from the RFIC 110.

The antenna module 100K is common to the antenna module 100J in a point that the three radiating elements are included but is configured such that a radiation frequency band is different from that of the antenna module 100J. For example, the antenna module 100K is configured to radiate radio waves with center frequencies of 28 GHz, 39 GHZ, and 100 GHz. Specifically, a radio wave with the center frequency of 100 GHz is radiated from the radiating element 121, a radio wave with the center frequency of 39 GHz is radiated from the radiating element 122, and a radio wave with the center frequency of 28 GHz is radiated from the radiating element 123.

That is, in the antenna module 100K, the frequency band of the radio wave radiated from the radiating element 121 is twice or more the frequency band of the radio waves radiated from the radiating element 122 and the radiating element 123. For this reason, there is a possibility that if a radio frequency signal is supplied to the radiating element 121, each of the radiating element 122 and the radiating element 124 resonates in the higher-order mode.

In the antenna module 100K in this Embodiment 6, the metal members 160 are disposed on the radiating element 122, and metal members 162 are disposed on the radiating element 124. Electrical coupling between the radiating element 122 and the feed wiring line 141K (or the feed wiring line 142K) and electrical coupling between the radiating element 124 and the feed wiring line 141K (or the feed wiring line 142K) are each thereby weakened. As the result, each of the radiating element 122 and the radiating element 124 may be prevented from resonating in the higher-order mode if a radio frequency signal is supplied to the radiating element 121, and the antenna gain of the radiating element 121 is improved.

As described above, also in the antenna module 100K of the triple-band-type, disposing the metal members 160 on the radiating element 122 and the metal member 162 on the radiating element 124 enables each of the radiating element 122 and the radiating element 124 to be prevented from resonating in the higher-order mode, and thus the antenna gain is improved.

The radiating elements 121 and 122, 124 in Embodiment 6 respectively correspond to the first radiating element, the second radiating element, and a fourth radiating element in the present disclosure. The metal members 160 and 162 in Embodiment 6 respectively correspond to the first metal member and a second metal member in the present disclosure. The feed wiring line 141K in Embodiment 6 corresponds to the first feed wiring line in the present disclosure.

### [Aspects]

(First aspect) An antenna module according to an aspect includes a ground electrode, a first radiating element and a second radiating element that are of a plate shape, a first feed wiring line through which a radio frequency signal is transmitted to the first radiating element, and at least one first metal member disposed on the second radiating element. The first radiating element is disposed to face the ground electrode. The second radiating element is larger than the first radiating element in size. In plan view in a normal direction of the ground electrode, the first radiating element is disposed between the ground electrode and the first radiating element to overlap with the first radiating element. The first feed wiring line penetrates through the second radiating element. The at least one first metal member is disposed to extend from the second radiating element in the normal direction, not in contact with the ground electrode.

(Second aspect) In the antenna module according to the first aspect, the first feed wiring line is electrically coupled to the first radiating element at a first feed point shifted from a center of the first radiating element in a first direction. A length of the at least one first metal member in an extending direction of the at least one first metal member is half a length of the first radiating element in the first direction.

(Third aspect) In the antenna module according to the first or second aspect, the first feed wiring line is electrically coupled to the first radiating element at a first feed point shifted from a center of the first radiating element in a first direction. On a cross section of the at least one first metal member, a maximum dimension of the at least one first metal member is one-tenth or less of the length of the first radiating element in the first direction, the cross section being orthogonal to the extending direction of the at least one first metal member.

(Fourth aspect) The antenna module according to any one of the first to third aspects further includes a second feed wiring line that penetrates through the second radiating element and through which a radio frequency signal is transmitted to the first radiating element. The first feed wiring line is electrically coupled to the first radiating element at the first feed point shifted from the center of the first radiating element in the first direction. The second feed wiring line is electrically coupled to the first radiating element at a second feed point shifted from the center of the first radiating element in a second direction different from the first direction. In plan view in the normal direction, the at least one first metal member is disposed to cause a first distance and a second distance to be identical, the first distance being from a point of connection between the at least one first metal member and the second radiating element to the first feed point, the second distance being from the point of connection to the second feed point.

(Fifth aspect) The antenna module according to any one of the first to fourth aspects further includes a third feed wiring line through which a radio frequency signal is transmitted to the second radiating element. In plan view of the at least one first metal member in the normal direction, a shortest distance from the point of connection between the at least one first metal member and the second radiating element to an end portion of the second radiating element is longer than a shortest distance from a third feed point to the end portion of the second radiating element, the third feed wiring line and the second radiating element being electrically coupled at the third feed point.

(Sixth aspect) In the antenna module according to any one of the first to fifth aspects, the at least one first metal member is disposed to extend in a direction from the second radiating element toward the ground electrode.

(Seventh aspect) In the antenna module according to any one of the first to sixth aspects, the at least one first metal member includes a plurality of first metal members.

(Eighth aspect) In the antenna module according to the seventh aspect, the plurality of first metal members include a first member and a second member that have mutually different lengths.

(Ninth aspect) The antenna module according to any one of the first to eighth aspects further includes: a second feed wiring line through which a radio frequency signal is transmitted to the first radiating element; and a third feed wiring line and a fourth feed wiring line through which radio frequency signals are transmitted to the second radiating element. The second feed wiring line penetrates through the second radiating element. The first feed wiring line is electrically coupled to the first radiating element at the first feed point shifted from the center of the first radiating element in the first direction. The second feed wiring line is electrically coupled to the first radiating element at the second feed point shifted from the center of the first radiating element in the second direction different from the first direction. The third feed wiring line is electrically coupled to the second radiating element at a third feed point shifted from a center of the second radiating element in a third direction. The fourth feed wiring line is electrically coupled to the second radiating element at a fourth feed point shifted from the center of the second radiating element in a fourth direction different from the third direction. In plan view in the normal direction, the first radiating element is disposed to superpose the center of the first radiating element on the center of the second radiating element. The third direction is opposite to the first direction across the center of the first radiating element. The fourth direction is opposite to the second direction across the center of the first radiating element.

(Tenth aspect) In the antenna module according to the ninth aspect, first metal members the number of which is 4n (n≥1) are disposed on the second radiating element. In plan view in the normal direction, a first metal member the number of which is n among the first metal members is disposed in each of four areas in the second radiating element, the four areas formed by division by using a first straight line and a second straight line, the first straight line connecting the first feed point and the third feed point, the second straight line connecting the second feed point and the fourth feed point.

(Eleventh aspect) In the antenna module according to the tenth aspect, in plan view in the normal direction, a first metal member the number of which is n among the first metal members and that is disposed in a first area of the four areas and a first metal member the number of which is n among the first metal members and that is disposed in a second area have a relationship of point symmetry with respect to the center of the first radiating element, the second area being located in point symmetry with the first area with respect to the center of the first radiating element. In plan view in the normal direction, a first metal member the number of which is n among the first metal members and that is disposed in a third area of the four areas and a first metal member the number of which is n among the first metal members and that is disposed in a fourth area have a relationship of point symmetry with respect to the center of the first radiating element, the fourth area being located in point symmetry with the third area with respect to the center of the first radiating element.

(Twelfth aspect) In the antenna module according to the tenth or eleventh aspect, the first metal member the number of which is n and that is disposed in the first area of the four areas is connected on a perpendicular bisector of a line connecting the first feed point and the second feed point in plan view in the normal direction, the first area being defined by a side passing through the first feed point and a side passing through the second feed point.

(Thirteenth aspect) In the antenna module according to the twelfth aspect, in plan view in the normal direction, the first direction is orthogonal to the second direction. The first metal member the number of which is n and that is disposed in the second area located in point symmetry with the first area with respect to the center of the first radiating element and the first metal member the number of which is n and that is disposed in the first area are disposed in point symmetry with respect to the center of the first radiating element. The first metal member the number of which is n and that is disposed in the third area adjacent to the first area across the first straight line and the first metal member the number of which is n and that is disposed in the first area are disposed in line symmetry with respect to the first straight line. The first metal member the number of which is n and that is disposed in the fourth area adjacent to the first area across the second straight line and the first metal member the number of which is n and that is disposed in the first area are disposed in line symmetry with respect to the second straight line.

(Fourteenth aspect) The antenna module according to any one of the first to thirteenth aspects further includes a third radiating element of a plate shape that is disposed between the first radiating element and the second radiating element to overlap with the first radiating element in plan view in the normal direction of the ground electrode. The first feed wiring line penetrates through the third radiating element. The third radiating element is larger in size than the first radiating element and is smaller in size than the second radiating element.

(Fifteenth aspect) The antenna module according to any one of the first to thirteenth aspects further includes a fourth radiating element of a plate shape that is disposed between the second radiating element and the ground electrode to overlap with the second radiating element in plan view in the normal direction of the ground electrode. The first feed wiring line penetrates through the fourth radiating element. The fourth radiating element is larger in size than the second radiating element.

(Sixteenth aspect) The antenna module according to the fifteenth aspect further includes at least one second metal member disposed to extend from the fourth radiating element in the normal direction without coming in contact with the ground electrode.

(Seventeenth aspect) The communication apparatus according to an aspect includes the antenna module according to any one of the first to sixteenth aspects.

The embodiments and the modifications disclosed this time are to be construed as being illustrative and not restrictive in all respects. It is intended that the scope of the present disclosure is defined by the scope of claims, not by the description of the embodiments and the modifications above, and include the meaning equivalent to the scope of claims and any change made within the scope.

### REFERENCE SIGNS LIST

10 communication apparatus
100, 100A to 100H, 100J, 100K antenna module
110A to 110D feeder circuit
111A to 111D, 113A to 113D, 117 switch
112AR to 112DR low-noise amplifier
112AT to 112DT power amplifier
114A to 114D attenuator
115A to 115D phase shifter
116 demultiplexer
118 mixer
119 amplifier circuit
120 antenna device
121 to 124 radiating element
130 dielectric substrate
131 upper surface
132 lower surface
141 to 146, 141F, 142F, 141G, 141H, 141J, 142J, 141K, 142K feed wiring line
150 bump
151 antenna element
160, 160A to 160N, 160P to 160S, 162 metal member
A1 to A4 area
GND ground electrode
SP1 to SP6 feed point

1. An antenna module comprising:
a ground electrode;
a first radiating element of a plate shape that faces the ground electrode;
a second radiating element of a plate shape between the ground electrode and the first radiating element to overlap the first radiating element in plan view in a normal direction of the ground electrode, the second radiating element being larger in size than the first radiating element;
a first feed wiring line that penetrates through the second radiating element and through which a radio frequency signal is transmitted to the first radiating element; and
at least one first metal member that extends from the second radiating element in the normal direction without being in contact with the ground electrode.

2. The antenna module according to claim 1,
wherein the first feed wiring line is electrically coupled to the first radiating element at a first feed point shifted from a center of the first radiating element in a first direction, and
wherein a length of the at least one first metal member in an extending direction of the at least one first metal member is half a length of the first radiating element in the first direction.

3. The antenna module according to claim 1,
wherein the first feed wiring line is electrically coupled to the first radiating element at the first feed point shifted from the center of the first radiating element in the first direction, and
wherein, on a cross section of the at least one first metal member, a maximum dimension of the at least one first metal member is one-tenth or less of the length of the first radiating element in the first direction, the cross section being orthogonal to the extending direction of the at least one first metal member.

4. The antenna module according to claim 1, further comprising:
a second feed wiring line that penetrates through the second radiating element and through which a radio frequency signal is transmitted to the first radiating element,
wherein the first feed wiring line is electrically coupled to the first radiating element at the first feed point shifted from the center of the first radiating element in the first direction,
wherein the second feed wiring line is electrically coupled to the first radiating element at a second feed point shifted from the center of the first radiating element in a second direction different from the first direction, and
wherein, in plan view in the normal direction, the at least one first metal member is disposed such that a first distance from a point of connection between the at least one first metal member and the second radiating element to the first feed point, and a second distance from the point of connection to the second feed point are equal.

5. The antenna module according to claim 1, further comprising:
a third feed wiring line through which a radio frequency signal is transmitted to the second radiating element,
wherein in plan view of the at least one first metal member in the normal direction, a shortest distance from the point of connection between the at least one first metal member and the second radiating element to an end portion of the second radiating element is longer than a shortest distance from a third feed point to the end portion of the second radiating element, the third feed wiring line and the second radiating element being electrically coupled at the third feed point.

6. The antenna module according to claim 1,
wherein the at least one first metal member extends in a direction from the second radiating element toward the ground electrode.

7. The antenna module according to claim 1,
wherein the at least one first metal member includes a plurality of first metal members.

8. The antenna module according to claim 7,
wherein the plurality of first metal members include a first member and a second member that have mutually different lengths.

9. The antenna module according to claim 8, wherein the first member is longer than the second member and closer to a center of the second radiating element than the second member.

10. The antenna module according to claim 7, wherein the plurality of first metal members extend from the second radiating element on only one side of a center of the second radiating element.

11. The antenna module according to claim 1,
wherein the at least one first metal member includes a plurality of first metal members,
the antenna module further comprising:
a second feed wiring line that penetrates through the second radiating element and through which a radio frequency signal is transmitted to the first radiating element; and
a third feed wiring line and a fourth feed wiring line through which radio frequency signals are transmitted to the second radiating element,
wherein the first feed wiring line is electrically coupled to the first radiating element at the first feed point shifted from the center of the first radiating element in the first direction,
wherein the second feed wiring line is electrically coupled to the first radiating element at the second feed point shifted from the center of the first radiating element in the second direction different from the first direction,
wherein the third feed wiring line is electrically coupled to the second radiating element at a third feed point shifted from a center of the second radiating element in a third direction,
wherein the fourth feed wiring line is electrically coupled to the second radiating element at a fourth feed point shifted from the center of the second radiating element in a fourth direction different from the third direction,
wherein, in plan view in the normal direction, the first radiating element is disposed to superpose the center of the first radiating element on the center of the second radiating element,
wherein the third direction is opposite to the first direction across the center of the first radiating element, and
wherein the fourth direction is opposite to the second direction across the center of the first radiating element.

12. The antenna module according to claim 11,
wherein the plurality of first metal is 4n (n≥1) first metal members, and
wherein, in plan view in the normal direction, four first metal member of the plurality of first metal members are singly disposed in corresponding four areas in the second radiating element, the four areas formed by division by using a first straight line and a second straight line, the first straight line connecting the first feed point and the third feed point, the second straight line connecting the second feed point and the fourth feed point.

13. The antenna module according to claim 11,
wherein, in plan view in the normal direction, n first metal members are disposed in a first area of the four areas and n first metal members are disposed in a second area have a relationship of point symmetry with respect to the center of the first radiating element, the second area being located in point symmetry with the first area with respect to the center of the first radiating element, and
wherein in plan view in the normal direction, n first metal members are in a third area of the four areas and n first metal members are in a fourth area have a relationship of point symmetry with respect to the center of the first radiating element, the fourth area being located in point symmetry with the third area with respect to the center of the first radiating element.

14. The antenna module according to claim 12,
wherein n first metal members in the first area of the four areas are connected on a perpendicular bisector of a line connecting the first feed point and the second feed point in plan view in the normal direction, the first area being defined by a side passing through the first feed point and a side passing through the second feed point.

15. The antenna module according to claim 14,
wherein, in plan view in the normal direction, the first direction is orthogonal to the second direction,
wherein the n first metal members in the second area located in point symmetry with the first area with respect to the center of the first radiating element and the n first metal member in the first area are disposed in point symmetry with respect to the center of the first radiating element,
wherein the n first metal member in the third area adjacent to the first area across the first straight line and the n first metal members in the first area are disposed in line symmetry with respect to the first straight line, and
wherein the n first metal member in the fourth area adjacent to the first area across the second straight line and the first metal member the count of which is n and that is disposed in the first area are disposed in line symmetry with respect to the second straight line.

16. The antenna module according to claim 1, further comprising:
a third radiating element of a plate shape that is disposed between the first radiating element and the second radiating element to overlap with the first radiating element in plan view in the normal direction of the ground electrode, and
wherein the first feed wiring line penetrates through the third radiating element, and
wherein the third radiating element is larger in size than the first radiating element and is smaller in size than the second radiating element.

17. The antenna module according to claim 1, further comprising:
a fourth radiating element of a plate shape that is disposed between the second radiating element and the ground electrode to overlap with the second radiating element in plan view in the normal direction of the ground electrode,
wherein the first feed wiring line penetrates through the fourth radiating element, and
wherein the fourth radiating element is larger in size than the second radiating element.

18. The antenna module according to claim 17, further comprising:
at least one second metal member disposed to extend from the fourth radiating element in the normal direction without contacting the ground electrode.

19. The antenna module according to claim 1,
wherein the at least one first metal member extends in a direction from the second radiating element toward the first radiating element.

20. A communication apparatus, comprising:
the antenna module according to claim 1.
